(19) United States
(12) Patent Application Publication
(10) Pub. No.: US 2011/0316181 A1
(43) Pub. Date: Dec. 29, 2011

(54) PROCESS OF MAKING ASYMMETRIC POLYBENZOXAZOLE MEMBRANES

(75) Inventors: Chunqing Liu, Schaumburg, IL (US); Raisa Minkov, Skokie, IL (US); Syed A. Faheem, Huntley, IL (US); Jaime G. Moscoso, Mount Prospect, IL (US)

(73) Assignee: UOP LLC, Des Plaines, IL (US)

(21) Appl. No.: 12/823,154

(22) Filed: Jun. 25, 2010

(51) Int. Cl. B01D 67/00; B01D 63/02

(52) U.S. Cl. 264/45.5; 264/45.8

(57) ABSTRACT

The present invention provides a process for making an integrally skinned asymmetric polybenzoxazole hollow fiber membrane comprising spinning a dope solution via a dry-wet phase inversion technique to form a porous integrally skinned asymmetric o-hydroxy substituted polyimide or an o-hydroxy substituted polyamide hollow fiber membrane comprising microporous inorganic molecular sieve followed by thermal rearrangement at a temperature from about 250° to 500° C. to convert the polyimide or polyamide membrane into a polybenzoxazole membrane. These membranes contain microporous inorganic molecular sieve materials that can have a particle size from about 20 nm to 10 μm.

### BACKGROUND OF THE INVENTION

This invention relates to a process of making integrally skinned asymmetric polybenzoxazole (PBO) membranes. The integrally skinned asymmetric PBO membranes comprise a microporous inorganic molecular sieve material and a PBO polymer derived from o-hydroxy substituted polyimide or o-hydroxy substituted polyamide. More particularly, these integrally skinned asymmetric PBO membranes may be hollow fiber membranes.

In the past 30-35 years, the state of the art of polymer membrane-based gas separation processes has evolved rapidly. Membrane-based technologies have advantages of both low capital cost and high-energy efficiency compared to conventional separation methods.

Membrane gas separation is of special interest to petroleum producers and refiners, chemical companies, and industrial gas suppliers. Several applications have achieved commercial success, including carbon dioxide removal from natural gas and from biogas and enhanced oil recovery, and also in hydrogen removal from nitrogen, methane, and argon in ammonia purge gas streams. For example, UOP's Separex™ cellulose acetate polymeric membrane is currently an international market leader for carbon dioxide removal from natural gas.

Cellulose acetate (CA) glassy polymer membranes are used extensively in gas separation. Currently, such CA membranes are used commercially for natural gas upgrading, including the removal of carbon dioxide. Although CA membranes have many advantages, they are limited in a number of properties including selectivity, permeability, and in chemical, thermal, and mechanical stability. It has been found that polymer membrane performance can deteriorate quickly. A primary cause of loss of membrane performance is liquid condensation on the membrane surface. Condensation can be prevented by providing a sufficient dew point margin for operation, based on the calculated dew point of the membrane product gas. UOP's MemGuard™ system, a regenerable adsorbent system that uses molecular sieves, was developed to remove water as well as heavy hydrocarbons from the natural gas stream, hence, to lower the dew point of the stream. The selective removal of heavy hydrocarbons by a pretreatment system can significantly improve the performance of the membranes. Although these pretreatment systems can effectively perform this function, the cost is quite significant. In some projects, the cost of the pretreatment system was as high as 10 to 40% of the total cost (pretreatment system and membrane system) depending on the feed composition. Reduction of the size of the pretreatment system or even total elimination of the pretreatment system would significantly reduce the membrane system cost for natural gas upgrading. Another factor is that, in recent years, more and more membrane systems have been installed in large offshore natural gas upgrading projects. The footprint is a big constraint for offshore projects. The footprint of the pretreatment system is very high at more than 10 to 50% of the footprint of the whole membrane system. Removal of the pretreatment system from the membrane system has great economic impact, especially to offshore projects.

Aromatic polybenzoxazoles (PBOs), polybenzothiazoles (PBTs), and polybenzimidazoles (PBIs) are thermally stable ladderlike glassy polymers with flat, stiff, rigid-rod phenylene-heterocyclic ring units. The stiff, rigid ring units in such polymers pack efficiently, leaving very small penetrant-accessible free volume elements that are desirable to provide polymer membranes with both high permeability and high selectivity. These aromatic PBO, PBT, and PBI polymers, however, have poor solubility in common organic solvents, preventing them from being used for making polymer membranes by the most practical solvent casting method.

Thermal conversion of soluble aromatic polyimides containing pendent functional groups ortho to the heterocyclic imide nitrogen in the polymer backbone to aromatic polybenzoxazoles (PBOs) or polybenzothiazoles (PBTs) has been found to provide an alternative method for creating PBO or PBT polymer membranes that are difficult or impossible to obtain directly from PBO or PBT polymers by solvent casting method. (Tullos et al, MACROMOLECULES, 32, 3598 (1999)) A recent publication in the journal SCIENCE reported high permeability polybenzoxazole polymer membranes in dense film geometry for gas separations (Ho Bum Park et al, SCIENCE 318, 254 (2007)). These polybenzoxazole membranes are prepared from high temperature thermal rearrangement of hydroxy-containing polyimide polymer membranes containing pendent hydroxyl groups ortho to the heterocyclic imide nitrogen. These polybenzoxazole polymer membranes exhibited extremely high CO₂ permeability (>100 Barrer) which is at least 10 times better than conventional polymer membranes. However, commercially viable integrally skinned asymmetric PBO membranes were not reported in this work.

Poly(o-hydroxy amide) polymers comprising pendent phenolic hydroxyl groups ortho to the amide nitrogen in the polymer backbone have also been used for making PBO membranes for separation applications (US 2010/0133188 A1).

One of the components to be separated by a membrane must have a sufficiently high permeance at the preferred conditions or extraordinarily large membrane surface areas are required to allow separation of large amounts of material. Permeance, measured in Gas Permeation Units (GPU, 1 GPU=7.5×10⁻⁹ m³ (STP)/m²s (kPa)), is the pressure normalized flux and equals to permeability divided by the skin layer thickness of the membrane. Commercially available polymer membranes, such as cellulose acetate and polysulfone membranes, have an asymmetric structure with a thin dense selective layer of less than 1 μm. The thin selective layer provides the membrane high permeance representing high productivity. Therefore, thick PBO dense films with around 50 μm thickness are unattractive for commercial gas separation applications. It is highly desirable to prepare asymmetric PBO membranes with high permeance for separation applications. One such type of asymmetric hollow fiber PBO membrane has been recently disclosed by Park et al. (US 2009/0297850 A1) and Visser et al. (Abstract on “Development of asymmetric hollow fiber membranes with tunable gas separation properties” at NAMS 2009 conference, Jun. 20-24, 2009, Charleston, S.C., USA). The asymmetric hollow fiber PBO membranes disclosed by Park et al. and Visser et al. were obtained from o-hydroxy substituted polyimide asymmetric hollow fiber membranes via thermal rearrangement. However, Visser et al. found out that the high temperature thermally rearranged asymmetric hollow fiber PBO membranes had low gas permeances (equivalent to a dense selective layer thickness of >5 μm). The low gas permeance is because the fiber shrank and the porous substructure collapsed during the thermal rearrangement at temperatures higher than 300° C.

Therefore, much more research is still required to reduce the excessive densification of the porous membrane substructure of asymmetric o-hydroxy substituted polyimide membranes during thermal rearrangement at elevated temperature to make asymmetric PBO membranes.

The present invention provides a process of making integrally skinned asymmetric PBO membranes with high selectivity and high permeance from relatively porous “parent” integrally skinned asymmetric o-hydroxy substituted polyimide or o-hydroxy substituted polyamide membranes. More particularly, these integrally skinned asymmetric PBO membranes may have hollow fiber geometry.

### SUMMARY OF THE INVENTION

The relatively porous “parent” integrally skinned asymmetric o-hydroxy substituted polyimide or o-hydroxy substituted polyamide hollow fiber membranes of the present invention are prepared via a dry-wet phase inversion technique by extruding a dope solution from a spinneret. The dope solution comprises a mixture of microporous inorganic molecular sieve particles, polymer or blend of polymers, solvents, and non-solvents. The solvent is selected from the group consisting of N-methylpyrrolidone, N-methyl-2-pyrrolidone, N,N-dimethyl formamide, 1,3-dioxolane, tetrahydrofuran, N,N-dimethyl acetamide, methylene chloride, dimethyl sulfoxide, 1,4-dioxane, mixtures thereof, others known to those skilled in the art and mixtures thereof. The non-solvent is selected from the group consisting of acetone, methanol, ethanol, isopropanol, 1-octane, 1-hexane, 1-heptane, lactic acid, citric acid, and mixtures thereof.

The dope solution comprises about 2 to 30 wt-% of microporous inorganic molecular sieve, about 6 to 43 wt-% of o-hydroxy substituted polyimide or o-hydroxy substituted polyamide, about 37 to 85 wt-% of solvents, and about 0 to 13 wt-% of non-solvents. The o-hydroxy substituted polyimide or o-hydroxy substituted polyamide has a weight average molecular weight (Mw) of about 70,000 to about 700,000.

The present invention provides a process of making integrally skinned asymmetric PBO hollow fiber membranes with high selectivity and high permeance from relatively porous “parent” integrally skinned asymmetric o-hydroxy substituted polyimide or o-hydroxy substituted polyamide hollow fiber membranes comprising microporous inorganic molecular sieve particles by spinning the above-mentioned dope solution via a dry-wet phase inversion technique to form the relatively porous “parent” integrally skinned asymmetric o-hydroxy substituted polyimide or o-hydroxy substituted polyamide hollow fiber membranes followed by thermal rearrangement at a temperature from 250° to 500° C. to convert the polyimide or polyamide membrane into a PBO membrane. This process comprises: (a) preparing a dope solution comprising a mixture of microporous inorganic molecular sieve particles, polymer or blend of polymers, solvents, and non-solvents; (b) spinning the dope solution and a bore fluid simultaneously from an annular spinneret using a hollow fiber spinning machine wherein said bore fluid comprising water and organic solvent is pumped into the center of the annulus and wherein said dope solution is pumped into the outer layer of the annulus; (c) passing the nascent hollow fiber membrane through an air gap between the surface of the spinneret and the surface of the nonsolvent coagulation bath to evaporate the organic solvents and non-solvents for a sufficient time to form the nascent hollow fiber membrane with a thin relatively porous and substantially void-containing selective layer on the surface; (d) immersing the nascent hollow fiber membrane into the nonsolvent (e.g., water) coagulation bath at a controlled temperature which is in a range of about 0° to 30° C. to generate the highly porous non-selective support region below the thin relatively porous and substantially void-containing selective layer by phase inversion, followed by winding up the hollow fibers on a drum, roll or other suitable device; (e) annealing the wet hollow fibers in a hot water bath at a temperature in a range of about 70° to 100° C. for about 10 minutes to about 3 hours; (f) washing the wet hollow fiber membranes with organic solvents such as methanol and hexane and drying the washed hollow fiber membranes at a temperature in a range of about 60° to 100° C. to remove the trace amount of organic solvents and water; (g) thermal rearrangement of the dried hollow fiber membranes to convert into PBO hollow fiber membranes by heating between about 250° and 500° C. under an inert atmosphere, such as argon, nitrogen, or vacuum. In some cases, a membrane post-treatment step can be added after step (g) by coating the selective skin layer surface of the membranes with a thin layer of high permeability material such as a polysiloxane, a fluoro-polymer, a thermally curable silicone rubber, or a UV radiation curable epoxy silicone.

### DETAILED DESCRIPTION OF THE INVENTION

This invention involves a process of making integrally skinned asymmetric polybenzoxazole (PBO) membranes. These integrally skinned asymmetric PBO membranes comprise a microporous inorganic molecular sieve material and a PBO polymer derived from o-hydroxy substituted polyimide or o-hydroxy substituted polyamide. More particularly, these integrally skinned asymmetric PBO membranes may have hollow fiber geometry. These integrally skinned asymmetric PBO membranes may also have flat sheet geometry.

It has been demonstrated by Tullos et al (MACROMOLECULES, 32, 3598 (1999)) and Ho Bum Park et al (SCIENCE 318, 254 (2007)) that o-hydroxy substituted polyimides can be thermally rearranged into PBOs at elevated temperature to obtain PBO membranes that are insoluble in organic solvents but have superior intrinsic gas permeation properties. Liu et al. (US 2010/0133188 A1) also showed that polyamides comprising pendent phenolic hydroxyl groups ortho to the amide nitrogen in the polymer backbone can be thermally rearranged into PBOs at elevated temperature to obtain PBO membranes.

However, Visser et al. (Abstract on “Development of asymmetric hollow fiber membranes with tunable gas separation properties” at NAMS 2009 conference, Jun. 20-24, 2009, Charleston, S.C., USA) disclosed that the integrally skinned asymmetric hollow fiber PBO membranes prepared from integrally skinned asymmetric hollow fiber o-hydroxy substituted polyimide membranes via high temperature thermal rearrangement had very low gas permeances (equivalent to a dense selective layer thickness of >5 μm).

Our experimental results also showed that integrally skinned asymmetric hollow fiber PBO membranes prepared from integrally skinned asymmetric hollow fiber o-hydroxy substituted polyimide membranes had CO₂ permeances lower than 8 GPU (at 50° C. under 791 kPa pure gas feed condition) although the integrally skinned asymmetric hollow fiber o-hydroxy substituted polyimide membranes had CO₂ permeances much higher than 8 GPU and CO₂/CH₄ selectivities higher than 25 (at 50° C. under 791 kPa pure gas feed condition). The low gas permeance is the result of hollow fiber shrinking and collapsing of the porous substructure during the thermal rearrangement at temperatures higher than 300° C. It has also been suggested by comparing hollow fiber membrane performance before and after heat treatment at 350° C. that the smaller the pore size in the porous substructure underneath the thin dense selective layer, the higher degree of densification in the porous substructure during heat treatment, corresponding to thicker dense selective layer and lower permeance.

Chiou (U.S. Pat. No. 6,368,382) disclosed a method of making an epoxysilicone coated membrane by coating a porous asymmetric membrane layer with a UV-curable epoxysilicone. The porous asymmetric membrane layer is comprised of an asymmetric polymer membrane with a low selectivity. The epoxysilicone coating was found to provide the porous asymmetric membrane layer with improved selectivity. However, Chiou did not teach the use of microporous inorganic molecular sieve material in the porous asymmetric membrane layer. Chiou also did not contemplate the preparation of asymmetric PBO membranes with a high selectivity using the porous asymmetric o-hydroxy substituted polyimide or o-hydroxy substituted polyamide membrane with a low selectivity.

In order to reduce the excessive densification of the porous membrane substructure of integrally skinned asymmetric o-hydroxy substituted polyimide or o-hydroxy substituted polyamide membranes during thermal rearrangement at elevated temperature to make integrally skinned asymmetric PBO membranes, the present invention describes a new concept of using relatively porous “parent” integrally skinned asymmetric o-hydroxy substituted polyimide or o-hydroxy substituted polyamide hollow fiber membrane comprising microporous inorganic molecular sieve particles and with low CO₂/CH₄ selectivity between 2 and 15 (at 50° C. under 791 kPa pure gas feed condition) to prepare integrally skinned asymmetric PBO hollow fiber membranes with high CO₂/CH₄ selectivity of at least 20 (at 50° C. under 791 kPa pure gas feed condition) via thermal rearrangement and without any epoxysilicone coating or other silicone coating. The relatively porous “parent” integrally skinned asymmetric o-hydroxy substituted polyimide or o-hydroxy substituted polyamide hollow fiber membrane comprises a microporous inorganic molecular sieve material and an o-hydroxy substituted polyimide or o-hydroxy substituted polyamide. The relatively porous “parent” integrally skinned asymmetric o-hydroxy substituted polyimide or o-hydroxy substituted polyamide hollow fiber membrane has an asymmetric structure with a relatively porous and substantial void-containing thin selectively semipermeable surface skin layer and a highly porous non-selective support region, with pore sizes ranging from large in the support region to very small proximate to the skin layer. The preferred thermal rearrangement temperature is from 250° to 500° C. The more preferred thermal rearrangement temperature is from 350° to 450° C. The geometry of the integrally skinned asymmetric PBO membranes can be flat sheet or hollow fiber. It has been demonstrated that the use of a relatively porous “parent” integrally skinned asymmetric o-hydroxy substituted polyimide or an o-hydroxy substituted polyamide membrane and the incorporation of microporous inorganic molecular sieve material such as AlPO-14 or AlPO-18 into the integrally skinned asymmetric o-hydroxy substituted polyimide or o-hydroxy substituted polyamide membrane have significantly reduced the membrane shrinkage and densification of the porous membrane substructure during thermal rearrangement.

The relatively porous “parent” integrally skinned asymmetric o-hydroxy substituted polyimide or o-hydroxy substituted polyamide hollow fiber membranes are prepared via a dry-wet phase inversion technique by extruding a dope solution from a spinneret. The dope solution comprises a mixture of microporous inorganic molecular sieve particles, polymer or blend of polymers, solvents, and non-solvents. The solvent is selected from the group consisting of N-methylpyrrolidone, N-methyl-2-pyrrolidone, N,N-dimethyl formamide, 1,3-dioxolane, tetrahydrofuran, N,N-dimethyl acetamide, methylene chloride, dimethyl sulfoxide, 1,4-dioxane, mixtures thereof, others known to those skilled in the art and mixtures thereof. The non-solvent is selected from the group consisting of acetone, methanol, ethanol, isopropanol, 1-octane, 1-hexane, 1-heptane, lactic acid, citric acid, and mixtures thereof.

The dope solution comprises about 2 to 30 wt-% of microporous inorganic molecular sieve particles, about 6 to 43 wt-% of o-hydroxy substituted polyimide or o-hydroxy substituted polyamide, about 37 to 85 wt-% of solvents, and about 0 to 13 wt-% of non-solvents. The o-hydroxy substituted polyimide or o-hydroxy substituted polyamide has a weight average molecular weight (Mw) of about 70,000 to about 700,000.

The present invention provides a process of making integrally skinned asymmetric PBO hollow fiber membranes with high selectivity and high permeance from relatively porous “parent” integrally skinned asymmetric o-hydroxy substituted polyimide or o-hydroxy substituted polyamide hollow fiber membranes comprising microporous inorganic molecular sieve particles by spinning the above-mentioned dope solution via a dry-wet phase inversion technique to form the relatively porous “parent” integrally skinned asymmetric o-hydroxy substituted polyimide or o-hydroxy substituted polyamide hollow fiber membranes followed by thermal rearrangement at a temperature from 250° to 500° C. to convert the polyimide or polyamide membrane into a PBO membrane. This process comprises: (a) preparing a dope solution comprising a mixture of microporous inorganic molecular sieve particles, polymer or blend of polymers, solvents, and non-solvents; (b) spinning the dope solution and a bore fluid simultaneously from an annular spinneret using a hollow fiber spinning machine wherein said bore fluid comprising water and organic solvent is pumped into the center of the annulus and wherein said dope solution is pumped into the outer layer of the annulus; (c) passing the nascent hollow fiber membrane through an air gap between the surface of the spinneret and the surface of the nonsolvent coagulation bath to evaporate the organic solvents and non-solvents for a sufficient time to form the nascent hollow fiber membrane with a thin relatively porous and substantially void-containing selective layer on the surface; (d) immersing the nascent hollow fiber membrane into the nonsolvent (e.g., water) coagulation bath at a controlled temperature which is in a range of about 0° to 30° C. to generate the highly porous non-selective support region below the thin relatively porous and substantially void-containing selective layer by phase inversion, followed by winding up the hollow fibers on a drum, roll or other suitable device; (e) annealing the wet hollow fibers in a hot water bath at a temperature in a range of about 70° to 100° C. for about 10 minutes to about 3 hours; (f) washing the wet hollow fiber membranes with organic solvents such as methanol and hexane and drying the washed hollow fiber membranes at a temperature in a range of about 60° to 100° C. to remove the trace amount of organic solvents and water; (g) thermal rearrangement of the dried hollow fiber membranes to convert into PBO hollow fiber membranes by heating between about 250° and 500° C. under an inert atmosphere, such as argon, nitrogen, or vacuum. In some cases, a membrane post-treatment step can be added after step (g) by coating the selective skin layer surface of the membranes with a thin layer of high permeability material such as a polysiloxane, a fluoro-polymer, a thermally curable silicone rubber, or a UV radiation curable epoxy silicone.

Any o-hydroxy substituted polyimide or o-hydroxy substituted polyamide can be used in the present invention. The ortho-positioned functional group with respect to the amine group may include OH, SH, or NH₂. Some preferred o-hydroxy substituted polyimide and o-hydroxy substituted polyamide polymers include poly[2,2′-bis-(3,4-dicarboxyphenyl)hexafluoropropane dianhydride-2,2-bis(3-amino-4-hydroxyphenyl)-hexafluoropropane] synthesized by polycondensation of 2,2′-bis-(3,4-dicarboxyphenyl)hexafluoropropane dianhydride (6FDA) with 2,2-bis(3-amino-4-hydroxyphenyl)-hexafluoropropane (APAF) (poly(6FDA-APAF)), poly[3,3′,4,4′-benzophenonetetracarboxylic dianhydride-2,2-bis(3-amino-4-hydroxyphenyl)-hexafluoropropane] (poly(BTDA-APAF)), poly(3,3′,4,4′-benzophenonetetracarboxylic dianhydride-3,3′-dihydroxy-4,4′-diamino-biphenyl) (poly(BTDA-HAB)), poly[4,4′-oxydiphthalic anhydride-2,2-bis(3-amino-4-hydroxyphenyl)-hexafluoropropane] (poly(ODPA-APAF)), poly[3,3′,4,4′-diphenylsulfone tetracarboxylic dianhydride-2,2-bis(3-amino-4-hydroxyphenyl)-hexafluoropropane] (poly(DSDA-APAF)), poly(3,3′,4,4′-diphenylsulfone tetracarboxylic dianhydride-3,3′-dihydroxy-4,4′-diamino-biphenyl) (poly(DSDA-HAB)), poly[2,2′-bis-(3,4-dicarboxyphenyl)hexafluoropropane dianhydride-3,3′,4,4′-benzophenonetetracarboxylic dianhydride-2,2-bis(3-amino-4-hydroxyphenyl)-hexafluoropropane] synthesized by polycondensation of 2,2′-bis-(3,4-dicarboxyphenyl)hexafluoropropane dianhydride (6FDA) and 3,3′,4,4′-benzophenonetetracarboxylic dianhydride (BTDA) (molar ratio of 6FDA to BTDA is 0.5:0.5) with 2,2-bis(3-amino-4-hydroxyphenyl)-hexafluoropropane (APAF) (molar ratio of 6FDA/BTDA/APAF is 0.5:0.5:1) (poly(6FDA-BTDA-APAF)), poly[4,4′-oxydiphthalic anhydride-2,2-bis(3-amino-4-hydroxyphenyl)-hexafluoropropane-3,3′-dihydroxy-4,4′-diamino-biphenyl] synthesized by polycondensation of 4,4′-oxydiphthalic anhydride (ODPA) with 2,2-bis(3-amino-4-hydroxyphenyl)-hexafluoropropane (APAF) and 3,3′-dihydroxy-4,4′-diamino-biphenyl (HAB) ((molar ratio of ODPA/APAF/HAB is 1:0.6:0.4)) (poly(ODPA-APAF-HAB)), poly[3,3′,4,4′-benzophenonetetracarboxylic dianhydride-2,2-bis(3-amino-4-hydroxyphenyl)-hexafluoropropane-3,3′-dihydroxy-4,4′-diamino-biphenyl] (poly(BTDA-APAF-HAB)), poly[2,2′-bis-(3,4-dicarboxyphenyl)hexafluoropropane dianhydride-3,3′-dihydroxy-4,4′-diamino-biphenyl] (poly(6FDA-HAB)), poly(4,4′-bisphenol A dianhydride-3,3′,4,4′-benzophenonetetracarboxylic dianhydride-2,2-bis(3-amino-4-hydroxyphenyl)-hexafluoropropane] (poly(BPADA-BTDA-APAF)), and poly(o-hydroxy amide) containing pendent —OH functional groups ortho to the amide nitrogen in the polymer backbone prepared by polycondensation of 2,2-bis(3-amino-4-hydroxyphenyl)-hexafluoropropane (APAF) with 4,4′-oxydibenzoyl chloride (ODBC).

Microporous inorganic molecular sieve particles were incorporated into the relatively porous “parent” integrally skinned asymmetric o-hydroxy substituted polyimide or o-hydroxy substituted polyamide hollow fiber membrane to further reduce the densification of the porous substructure during high temperature thermal rearrangement to make asymmetric PBO hollow fiber membrane. The organic nature of the o-hydroxy substituted polyimide or o-hydroxy substituted polyamide polymer in the membrane caused the entire membrane to shrink during high temperature exposure. This shrinking resulted in the densification of the porous substructure and thicker dense selective layer, which decreased the permeance of the PBO membrane. Microporous inorganic molecular sieves such as AlPO-14 and AlPO-18, however, are inorganic and thus have less shrinking than the organic polymer when exposed to high temperatures. The particle size of the microporous inorganic molecular sieve particles used in the present invention can be in a range from 20 nm to 10 μm. Nano-sized microporous inorganic molecular sieve particles are not required for the application in the present invention. Any type of microporous inorganic molecular sieves or surface-treated microporous inorganic molecular sieves that can form good adhesion between the microporous inorganic molecular sieve particles and the o-hydroxy substituted polyimide or o-hydroxy substituted polyamide polymer can be used in the present invention. The most preferred microporous inorganic molecular sieves include AlPO-14, AlPO-18, AlPO-17, and AlPO-34.

In the present invention, the high temperature thermal rearrangement of the relatively porous “parent” integrally skinned asymmetric o-hydroxy substituted polyimide or o-hydroxy substituted polyamide hollow fiber membrane comprising microporous inorganic molecular sieve particles significantly reduces the pore size of the small pores to <0.5 nm or completely closes the small pores in the relatively porous selective layer of the membrane. Furthermore, the incorporation of microporous inorganic molecular sieve particles into the relatively porous “parent” integrally skinned asymmetric o-hydroxy substituted polyimide or o-hydroxy substituted polyamide hollow fiber membrane significantly reduces membrane shrinkage and densification of porous membrane substructures during thermal rearrangement. As an example, several porous “parent” integrally skinned asymmetric poly[2,2′-bis-(3,4-dicarboxyphenyl)hexafluoropropane dianhydride-3,3′-dihydroxy-4,4′-diamino-biphenyl] (6FDA-HAB) hollow fiber membranes comprising AlPO-14 molecular sieve particles and 6FDA-HAB polyimide polymer have low CO₂/CH₄ selectivities of 3-10 (at 50° C. under 791 kPa pure gas feed condition). These membranes have been converted to high selectivity integrally skinned asymmetric PBO hollow fiber membranes with CO₂/CH₄ selectivities of 26 to 35 and CO₂ permeances of 46 to 139 GPU (at 50° C. under 791 kPa pure gas feed condition) via thermal rearrangement at 400° C. in a tube furnace under N₂ environment.

The integrally skinned asymmetric PBO hollow fiber membranes are useful in separations including, but not limited to, gas separations, such as H₂/CH₄, H₂/N₂, O₂/N₂, CO₂/N₂, CO₂/CH₄, olefin/paraffin, and linear-/branched-hydrocarbons, and vapor or liquid separations, such as H₂O/ethanol, H₂O/propanol, xylene isomer separations, olefin/paraffin, linear-/branched-hydrocarbons, and sulfur compounds/hydrocarbons.

The following examples illustrate how to make and use the membranes of the present invention.

### Example 1

### Preparation of Asymmetric O-Hydroxy Substituted Polyimide Hollow Fiber Membrane (PI-1)

A hollow fiber spinning dope solution containing 22.0 g of poly[2,2′-bis-(3,4-dicarboxyphenyl)hexafluoropropane dianhydride-3,3′-dihydroxy-4,4′-diamino-biphenyl] (poly(6FDA-HAB)) synthesized by polycondensation of 2,2′-bis-(3,4-dicarboxyphenyl) hexafluoropropane dianhydride with 3,3′-dihydroxy-4,4′-diamino-biphenyl, 6.59 g of microporous AlPO-14 molecular sieve particles with thin plate morphology, 45.54 g of N-methylpyrrolidone (NMP), 6.16 g of 1,3-dioxolane, 1.82 g of isopropanol, and 1.82 g of acetone was prepared by dispersing 6.59 g of AlPO-14 molecular sieves in 45.54 g of NMP solvent by ultrasonication to form a slurry. Then 4.5 g of poly(6FDA-HAB) polyimide was added to functionalize AlPO-14 molecular sieves in the slurry. The slurry was rolled on a roller with very low speed for at least 12 hours to completely dissolve the poly(6FDA-HAB) polymer and then was ultrasonicated to functionalize the outer surface of the AlPO-14 molecular sieve. After that, another 4.5 g of poly(6FDA-HAB), 6.16 g of 1,3-dioxolane, 1.82 g of isopropanol, and 1.82 g of acetone were added to the slurry and the resulting mixture was rolled on a roller with very low speed for at least 24 hours to completely dissolve the poly(6FDA-HAB) polymer. Finally, 13 g of poly(6FDA-HAB) polymer was added to the dope solution and was rolled on a roller with very low speed for at least 48 hours to form a stable spinning dope solution. The dope solution has 613,000 cp viscosity at 30° C. and was allowed to degas overnight before spinning.

The spinning dope was extruded from the annulus of a hollow fiber membrane spinneret at a flow rate of 0.7 mL/min at 50° C. spinning temperature. A bore fluid containing 10% by weight of water in NMP was flowed from the inner passage of the spinneret at a flow rate of 0.4 mL/min simultaneously with the extruding of the spinning dope. The nascent fiber passed through an air gap length of 3 cm at room temperature to form a thin relatively porous and substantially void-containing selective layer on the surface of the fiber, and then immersed into a water coagulant bath at 8° C. to allow liquid-liquid demixing, and formation of the asymmetric highly porous non-selective support region below the thin relatively porous and substantially void-containing selective layer by phase inversion, and wound up on a take-up drum partially submersed in water at a rate of 8.0 m/min. The water-wet fibers were annealed in a hot water bath at 85° C. for 30 min. The annealed water-wet fibers were then sequentially exchanged with methanol and hexane for three successive times and for 30 min each time, followed by drying at 100° C. for 1 hour to form a PI-1 hollow fiber membrane.

### Example 2

### Preparation of Asymmetric PBO Hollow Fiber Membrane (PBO-1) from PI-1 Hollow Fiber Membrane

The PI-1 hollow fibers were thermally rearranged by heating from 25° to 400° C. at a heating rate of 15° C./min in a regular tube furnace under N₂ flow. The membrane was held for 10 min at 400° C. and then cooled down to 150° C. at a heating rate of 15° C./min under N₂ flow to yield PBO-1 hollow fiber membrane.

### Example 3

### Preparation of Asymmetric O-Hydroxy Substituted Polyimide Hollow Fiber Membrane (PI-2)

Polyimide hollow fiber membrane PI-2 was prepared as in Example 1, except that the dope flow rate was 1.1 mL/min, and the fiber take-up rate was approximately 10 m/min.

### Example 4

### Preparation of Asymmetric PBO Hollow Fiber Membrane (PBO-2) from PI-2 Hollow Fiber Membrane

The PI-2 hollow fiber membrane was thermally rearranged into PBO-2 hollow fiber membrane following the same procedure as in Example 2.

### Example 5

### Preparation of Asymmetric O-Hydroxy Substituted Polyimide Hollow Fiber Membrane (PI-3)

Polyimide hollow fiber membranes were prepared as in Example 1, except that the air gap length was 5 cm.

### Example 6

### Preparation of Asymmetric PBO Hollow Fiber Membrane (PBO-3) from PI-3 Hollow Fiber Membrane

The PI-3 hollow fiber membrane was thermally rearranged into PBO-3 hollow fiber membrane following the procedure same as in Example 2.

### Example 7

### Preparation of Asymmetric O-Hydroxy Substituted Polyimide Hollow Fiber Membrane (PI-4)

Polyimide hollow fiber membranes were prepared as in Example 1, except that the dope solution had a viscosity of 125,000 cp and comprised 20.0 g of poly(6FDA-HAB), 6.0 g of microporous AlPO-14 molecular sieve particles with thin plate morphology, 43.32 g of NMP, 5.85 g of 1,3-dioxolane, 1.73 g of isopropanol, and 1.73 g of acetone, dope flow rate was 2.6 mL/min and the bore fluid rate was 0.8 mL/min, and the fiber take-up rate was approximately 23.5 m/min.

### Example 8

### Preparation of Asymmetric PBO Hollow Fiber Membrane (PBO-4) from PI-4 Hollow Fiber Membrane

The PI-4 hollow fiber membrane was thermally rearranged into PBO-4 hollow fiber membrane following the procedure same as in Example 2.

### Example 9

### CO₂/CH₄ Separation Performance of Polyimide and PBO Hollow Fiber Membranes

Single-gas permeances of CO₂ and CH₄ through the relatively porous “parent” integrally skinned asymmetric o-hydroxy substituted polyimide hollow fiber membranes prepared in Examples 1, 3, 5, and 7 (PI-1, PI-2, PI-3, and PI-4, respectively) and the asymmetric PBO hollow fiber membranes prepared in Examples 2, 4, 6, and 8 (PBO-1, PBO-2, PBO-3, and PBO-4, respectively) were measured at 50° C. under 791 kPa (100 psig) feed gas pressure with the feed on the bore-side of the hollow fibers. Performance of these membranes is shown in Table 1. Comparison of the polyimide membranes PI-1, PI-2, and PI-3 to the PBO membranes PBO-1, PBO-2, and PBO-3 prepared via thermal rearrangement of PI-1, PI-2, and PI-3 membranes, respectively shows that the CO₂/CH₄ selectivities were significantly improved from 2.7-3.3 to 26-30 by thermal rearrangement of the polyimide membranes at 400° C. for 10 min. As an example, PBO-1 hollow fiber membrane prepared from the low CO₂/CH₄ selectivity PI-1 hollow fiber membrane has shown CO₂ permeance of 139 GPU and single-gas α_{CO2/CH4} of 26.4. Comparison of the polyimide membrane PI-4 to the PBO membrane PBO-4 shows that thermal rearrangement of the porous “parent” integrally skinned asymmetric o-hydroxy substituted polyimide hollow fiber membrane with CO₂/CH₄ selectivity below 2 cannot provide PBO membrane with high CO₂/CH₄ selectivity.

TABLE 1
Single-gas CO₂ and CH₄ permeation performance permeation
performance of PI and PBO hollow fiber membranes

| Hollow fiber | CO₂ permeance | CO₂/CH₄ |
|---|---|---|
| membrane | (GPU) | selectivity |
| PI-1 | 327 | 2.7 |
| PBO-1 | 139 | 26.4 |
| PI-2 | 704 | 3.0 |
| PBO-2 | 70 | 29.6 |
| PI-3 | 724 | 3.3 |
| PBO-3 | 46 | 28 |
| PI-4 | 931 | 1.6 |
| PBO-4 | 357 | 4.1 |

(1 GPU = 7.5 × 10⁻⁹ m³ (STP)/m² s (kPa))

### Example 10

### Preparation of Silicone Rubber-Coated Asymmetric PBO Hollow Fiber Membrane (PBO-2-Si) from PBO-2 Hollow Fiber Membrane

The PBO-2 hollow fibers were coated with a thermally curable silicone rubber solution containing 1.8 wt-% of RTV615A, 0.2 wt-% of RTV615B, and 98 wt-% of hexane inside the hollow fiber testing module and thermally cured at 100° C. for 1 hour.

### Example 11

### Preparation of Silicone Rubber-Coated Asymmetric PBO Hollow Fiber Membrane (PBO-3-Si) from PBO-3 Hollow Fiber Membrane

The PBO-3 hollow fibers were coated with a thermally curable silicone rubber solution containing 1.8 wt-% of RTV615A, 0.2 wt-% of RTV615B, and 98 wt-% of hexane inside the hollow fiber testing module and thermally cured at 100° C. for 1 hour.

### Example 12

### CO₂/CH₄ Separation Performance of PBO and Silicone Rubber-Coated PBO Hollow Fiber Membranes

Single-gas permeances of CO₂ and CH₄ through the asymmetric PBO hollow fiber membranes prepared in Examples 4 and 6 (PBO-2 and PBO-3 respectively) and the corresponding silicone rubber-coated asymmetric PBO hollow fiber membranes prepared in Examples 10 and 11 (PBO-2-Si and PBO-3-Si respectively) were measured at 50° C. under 791 kPa (100 psig) feed gas pressure with the feed on the bore-side of the hollow fibers. Performance of these membranes is shown in Table 2. Comparison of the PBO-2 and PBO-3 membrane with the corresponding silicone rubber-coated PBO-2-Si and PBO-3-Si membranes shows that the CO₂/CH₄ selectivities were further improved by a silicone rubber coating.

TABLE 2
Single-gas CO₂ and CH₄ permeation performance of PBO
and silicone rubber-coated PBO hollow fiber membranes

| Hollow fiber | CO₂ permeance | CO₂/CH₄ |
|---|---|---|
| membrane | (GPU) | selectivity |
| PBO-2 | 70 | 29.6 |
| PBO-2-Si | 38 | 43.9 |
| PBO-3 | 46 | 28 |
| PBO-3-Si | 26 | 71 |

(1 GPU = 7.5 × 10⁻⁹ m³ (STP)/m² s (kPa))

1. A process for making an integrally skinned asymmetric polybenzoxazole hollow fiber membrane comprising spinning a dope solution via a dry-wet phase inversion technique to form a porous integrally skinned asymmetric o-hydroxy substituted polyimide or o-hydroxy substituted polyamide hollow fiber membrane comprising microporous inorganic molecular sieve and o-hydroxy substituted polyimide or o-hydroxy substituted polyamide followed by thermal rearrangement at a temperature from about 250° to 500° C. to convert the said porous integrally skinned asymmetric o-hydroxy substituted polyimide or o-hydroxy substituted polyamide hollow fiber membrane into an integrally skinned asymmetric polybenzoxazole hollow fiber membrane with a nonporous selective skin layer.

2. The process of claim 1 wherein a membrane post-treatment step takes place after said thermal rearrangement wherein said nonporous selective skin layer surface of the polybenzoxazole membrane is coated with a thin layer of high permeability material selected from the group consisting of a polysiloxane, a fluoro-polymer, a thermally curable silicone rubber, and a UV radiation curable epoxy silicone.

3. The process of claim 1 wherein said dope solution comprises a solvent selected from the group consisting of N-methylpyrrolidone, N-methyl-2-pyrrolidone, N,N-dimethyl formamide, 1,3-dioxolane, tetrahydrofuran, N,N-dimethyl acetamide, methylene chloride, dimethyl sulfoxide, 1,4-dioxane, and mixtures thereof.

4. The process of claim 1 wherein said dope solution comprises a non-solvent selected from the group consisting of acetone, methanol, ethanol, isopropanol, 1-octane, 1-hexane, 1-heptane, lactic acid, citric acid, and mixtures thereof.

5. The process of claim 1 wherein said dope solution comprises about 2 to 30 wt-% of said microporous inorganic molecular sieve, about 6 to 43 wt-% of said o-hydroxy substituted polyimide or said o-hydroxy substituted polyamide, about 37 to 85 wt-% of said solvents, and about 0 to 13 wt-% of said non-solvents.

6. The process of claim 1 wherein said o-hydroxy substituted polyimide or said o-hydroxy substituted polyamide have a weight average molecular weight (Mw) of about 70,000 to about 700,000.

7. The process of claim 1 wherein said thermal rearrangement is at a temperature from about 350° to 450° C.

8. The process of claim 1 wherein said microporous inorganic molecular sieve has a particle size from about 20 nm to 10 μm.

9. The process of claim 1 wherein said microporous inorganic molecular sieve is selected from the group consisting of AlPO-14, AlPO-18, AlPO-17 and AlPO-34.

10. The process of claim 1 wherein said o-hydroxy substituted polyimide or said o-hydroxy substituted polyamide are selected from the group consisting of poly[2,2′-bis-(3,4-dicarboxyphenyl)hexafluoropropane dianhydride-2,2-bis(3-amino-4-hydroxyphenyl)-hexafluoropropane] (poly(6FDA-APAF)), poly[3,3′,4,4′-benzophenonetetracarboxylic dianhydride-2,2-bis(3-amino-4-hydroxyphenyl)-hexafluoropropane] (poly(BTDA-APAF)), poly(3,3′,4,4′-benzophenonetetracarboxylic dianhydride-3,3′-dihydroxy-4,4′-diamino-biphenyl) (poly(BTDA-HAB)), poly[4,4′-oxydiphthalic anhydride-2,2-bis(3-amino-4-hydroxyphenyl)-hexafluoropropane] (poly(ODPA-APAF)), poly[3,3′,4,4′-diphenylsulfone tetracarboxylic dianhydride-2,2-bis(3-amino-4-hydroxyphenyl)-hexafluoropropane] (poly(DSDA-APAF)), poly(3,3′,4,4′-diphenylsulfone tetracarboxylic dianhydride-3,3′-dihydroxy-4,4′-diamino-biphenyl) (poly(DSDA-HAB)), poly[2,2′-bis-(3,4-dicarboxyphenyl)hexafluoropropane dianhydride-3,3′,4,4′-benzophenonetetracarboxylic dianhydride-2,2-bis(3-amino-4-hydroxyphenyl)-hexafluoropropane] (poly(6FDA-BTDA-APAF)), poly[4,4′-oxydiphthalic anhydride-2,2-bis(3-amino-4-hydroxyphenyl)-hexafluoropropane-3,3′-dihydroxy-4,4′-diamino-biphenyl] (poly(ODPA-APAF-HAB)), poly[3,3′,4,4′-benzophenonetetracarboxylic dianhydride-2,2-bis(3-amino-4-hydroxyphenyl)-hexafluoropropane-3,3′-dihydroxy-4,4′-diamino-biphenyl] (poly(BTDA-APAF-HAB)), poly[2,2′-bis-(3,4-dicarboxyphenyl)hexafluoropropane dianhydride-3,3′-dihydroxy-4,4′-diamino-biphenyl] (poly(6FDA-HAB)), poly(4,4′-bisphenol A dianhydride-3,3′,4,4′-benzophenonetetracarboxylic dianhydride-2,2-bis(3-amino-4-hydroxyphenyl)-hexafluoropropane] (poly(BPADA-BTDA-APAF)), and poly(o-hydroxy amide) containing pendent —OH functional groups ortho to the amide nitrogen in the polymer backbone prepared by polycondensation of 2,2-bis(3-amino-4-hydroxyphenyl)-hexafluoropropane (APAF) with 4,4′-oxydibenzoyl chloride (ODBC).

11. The process of claim 1 wherein said integrally skinned asymmetric polybenzoxazole hollow fiber membrane has a selectivity for CO₂/CH₄ of about 26-35 at 50° C. under 791 kPa pure gas feed pressure.

12. The process of claim 1 wherein said integrally skinned asymmetric polybenzoxazole hollow fiber membrane is then used in a gas separation selected from the group consisting of H₂/CH₄, H₂/N₂, O₂/N₂, CO₂/N₂, CO₂/CH₄, olefin/paraffin, and linear-hydrocarbons/branched-hydrocarbons.

13. The process of claim 1 wherein said integrally skinned asymmetric polybenzoxazole hollow fiber membrane is then used in a vapor or liquid separations selected from the group consisting of water/ethanol, water/propanol, xylene isomer separations, olefin/paraffin, linear-/branched-hydrocarbons, and sulfur compounds/hydrocarbons.

14. A process of making integrally skinned asymmetric polybenzoxazole hollow fiber membrane comprising:
a) preparing a dope solution comprising a mixture of microporous inorganic molecular sieve, polymer or blend of polymers, solvents, and non-solvents;
b) spinning the dope solution and a bore fluid simultaneously from an annular spinneret using a hollow fiber spinning machine wherein said bore fluid comprises water and an organic solvent is pumped into the center of the annulus and wherein said dope solution is pumped into the outer layer of the annulus;
c) passing the nascent hollow fiber membrane through an air gap between the surface of the spinneret and the surface of the nonsolvent coagulation bath to evaporate the organic solvents and non-solvents for a sufficient time to form the nascent hollow fiber membrane with a thin relatively porous and substantially void-containing selective layer on the surface;
d) immersing the nascent hollow fiber membrane into the nonsolvent (e.g., water) coagulation bath at a controlled temperature which is in a range of about 0° to 30° C. to generate the highly porous non-selective support region below the thin relatively porous and substantially void-containing selective layer by phase inversion, followed by winding up the hollow fibers on a drum, roll or other suitable device;
e) annealing the wet hollow fibers in a hot water bath at a temperature in a range of about 70° to 100° C. for about 10 minutes to about 3 hours;
f) washing the wet hollow fiber membranes with organic solvents and then drying the washed hollow fiber membranes at a temperature in a range of about 60° to 100° C. to remove trace amounts of organic solvents and water; and
g) thermally rearranging the dried hollow fiber membranes by applying heating between about 250° and 500° C. under an inert atmosphere.
